(19) United States
(12) Patent Application Publication
(10) Pub. No.: US 2006/0127170 A1
(43) Pub. Date: Jun. 15, 2006

(54) Spring holding connectors

(76) Inventor: Pete Balsells, Newport Beach, CA (US)

Correspondence Address: WALTER A. HACKLER, 2372 S.E. BRISTOL, SUITE B, NEWPORT BEACH, CA, 92660-0755, US

(21) Appl. No.: 11/345,911

(22) Filed: Feb. 2, 2006

Related U.S. Application Data
(63) Continuation of application No. 10/777,974, filed on Feb. 12, 2004, now abandoned.
(60) Provisional application No. 60/448,004, filed on Feb. 18, 2003.

(51) Int. Cl. F16F 1/38

(52) U.S. Cl. 403/225

(57) ABSTRACT

A spring holding connector includes a housing having a bore therethrough and a shaft rotatably and slidably received in the bore, a circular groove is in one of said bore and shaft and a circular spring disposed in the groove for slidably holding said shaft within the bore. The groove is sized and shaped for controlling, in combination with a spring configuration, shaft mobility within the bore.

The present application is a continuation of U.S. Ser. No. 10/777,974 filed Feb. 12, 2004, now abandoned. This application is to be incorporated herein.

The present invention relates to canted coil springs that are mounted in grooves that can either be disposed in a housing or the shaft for the purpose of holding such shaft or housing from movement which can be axial or rotary and in some cases, permit the passing of current from the housing through the spring onto the shaft and vice versa. Retaining a shaft or a housing offers some significant advantages in case where a certain force needs to be developed to hold a piston or shaft and at the same time provide other benefits, such as electrical conductivity, shielding against EMI and others.

Connectors used in holding applications have been described extensively, as for example, U.S. Pat. No. 4,974,821, 5,139,276, 5,082,390, 5,545,842, 5,411,348 to Balsells, and others. All of these patents are to be incorporated herewith by this specific references thereto.

Of these cited U.S. Pat. No. 4,974,821 generally describes canted coil springs and a groove for orienting the spring for major axis radial loading for enabling a specific preselected characteristic in response to loading of the spring.

U.S. Pat. No. 5,082,390 teaches a canted coil spring for holding and locking a first and second number to one another.

U.S. Pat. No. 5,139,276 discloses a radially loaded spring in a groove for controlling resilient characteristics of the spring.

U.S. Pat. No. 5,411,348 and U.S. Pat. No. 5,545,842 teach spring mechanisms which preferentially lock two members together.

None of the cited references or any prior art provides for controlling shaft mobility within a bore.

This patent invention provides for various types of novel groove designs disposed in a piston, a shaft, and/or housing. Different spring design configurations are provided that affect holding, force variation, resistivity variation, and other variations under static and dynamic loading conditions between the housing, the spring, and the shaft by appropriate groove, spring and material combinations.

### SUMMARY OF THE INVENTION

A spring holding connector in accordance with the present invention generally includes a housing having a bore therethrough with shaft rotatably and/or slidably received within the bore.

A circular groove is formed in either the bore or the shaft and a circular spring is disposed in the groove for slidably holding the shaft within the bore. Importantly, the groove is sized and shaped, in combination with a spring configuration, for controlling shaft mobility within the bore.

This causes movement of the shaft within the bore to require differing forces dependent upon direction of shaft movement.

In one embodiment of the present invention, a spring is turnable within the groove for causing forces required to move the shaft within the bore to be dependent upon the direction of the movement. In another embodiment, the spring is compressible within the groove for causing forces required to move the shaft within the bore to be dependent upon a direction of movement. Both turning and compression of the spring in combination further, in combination, provide for a differentiation of forces necessary to move the shaft within the bore to be dependent upon the direction of movement.

Such movement may be axial and further the spring may be turnable in the groove for enabling electroconductivity between the shaft and the housing to be improved by removing oxidation which may form on the spring. In this embodiment, the groove may include an uneven bottom for scraping the spring as the spring turns therepast.

In accordance with the present invention, the spring may be a counterclockwise radial spring or a clockwise radial spring depending upon the shaft mobility requirements.

Alternatively, the spring may be an axial spring having a back angle at an inside diameter of the spring coils and a front angle on an outside diameter the spring coils.

Alternatively, the spring may be an axial spring having a back angle on an outside diameter of the spring, coils and a front angle on an inside diameter of the spring coils. This again is important in providing the differential force requires as hereinabove noted.

More specifically, the groove may be sized and shaped for causing a combination of the spring and groove combination to produce a force required to move the shaft in one axial direction to be greater by about 300% of the force required to move the shaft in the opposite axial direction. This force differentiation may be as high as 1200% or more depending upon a groove and a spring selection as hereinafter set forth.

In one embodiment of the present invention, the groove has a tapered bottom and in another embodiment the groove may have a flat bottom.

The groove further may include a V-bottom, a tapered V-bottom, a semi-tapered V-bottom, or a round bottom with a shoulder thereon.

In addition, the connector may include the grooves with inverted V-bottoms with a different angles as subtending sides of the groove. A dovetail groove may also be utilized and the groove may include an inwardly facing lip disposed opposite a groove bottom all of the groove, all such embodiments being hereinafter described in greater detail.

### BRIEF DESCRIPTION OF THE DRAWINGS

The advantages and features of the present invention will be better understood by the following description when considered in conjunction with the accompanying drawings in which:

FIGS. 1a-1e show different positions of a counter clockwise radial spring;

FIGS. 2a-2c show a counter clockwise radial spring and a flat bottom housing groove;

FIGS. 3a-3c show a clockwise radial spring and a flat bottom housing groove;

FIGS. 4a-4b shows a RF clockwise axial spring and a tapered bottom groove;

FIGS. 5a-5d shows an RF clockwise axial spring mounted in a tapered bottom groove;

FIGS. 6a-6c are similar to FIGS. 4a-4d and 5a-5d with the spring mounted in a piston groove;

FIGS. 7a-7c are similar to FIGS. 6a-6c shown a different direction of shaft movement;

FIGS. 8a-8c and 9a-9c make a comparison to the configuration shown in FIGS. 4 and 5 in which an F axial spring is utilized;

FIGS. 10a-10c and 11a-11c shown an F spring mounted in a piston;

FIGS. 12a-12g show a counter clockwise radial spring turn 90° clockwise into a counter clockwise axial F spring and assembled in a groove with the groove width smaller than the coil height;

FIGS. 13a-13g show a counter clockwise radial spring turn 90° clockwise into a clockwise axial RF spring assembled in a groove with the groove width smaller than the coil height;

FIGS. 14a-14g show a counter clockwise radial spring turn 90° clockwise into a clockwise axial RF spring and assembled in a groove with a groove width smaller than the coil height;

FIGS. 15a-15g show a counter clockwise radial spring turned 90° clockwise into a counter clockwise axial F spring and assembled in a groove with a groove width smaller than the coil height;

FIGS. 16a-16b and 17a-17b show axial RF and F springs with a shaft shown moving in a concave direction of the spring ID as shown in FIGS. 16a and 16b and FIGS. 17a-17b showing the shaft moving in a convex direction of the spring ID;

FIGS. 18 and 19 illustrate that when a pin is moved away from a turn angle “A” the running force developed a substantially less than when the pin moves toward the tapered angle “A”, with the spring turning clockwise;

FIGS. 20a-20c show radial spring in which the free spring outside diameter is greater than the bore outside diameter;

FIG. 21a-21c shows a radial spring in which the free spring outside diameter is equal to the bore outside diameter;

FIGS. 22a-22c show radial spring mounted in a piston in which the spring ID is smaller than the piston groove diameter;

FIGS. 23a-23c show a radial spring mounted on a piston in which the spring ID is equal to a piston groove diameter;

FIG. 24 shows the radial spring compression with various housing bore diameters;

FIG. 25 illustrates a constant housing bore diameter with a variable shaft diameter;

FIGS. 26a-26b illustrate F springs versus RF springs mounted in a housing;

FIGS. 27a-27b show F springs versus RF springs mounted on a piston;

FIGS. 28a-28c show a variation of an RF spring diameter and its effect on forces;

FIGS. 29a-29c compare the variation of an F spring diameter and its effect on force; and

FIGS. 30-37 show different kinds of groove spring configurations having a flat bottom groove, both on the housing and on the piston using axial springs and-a groove in which the groove width is smaller than the groove height.

### DETAILED DESCRIPTION

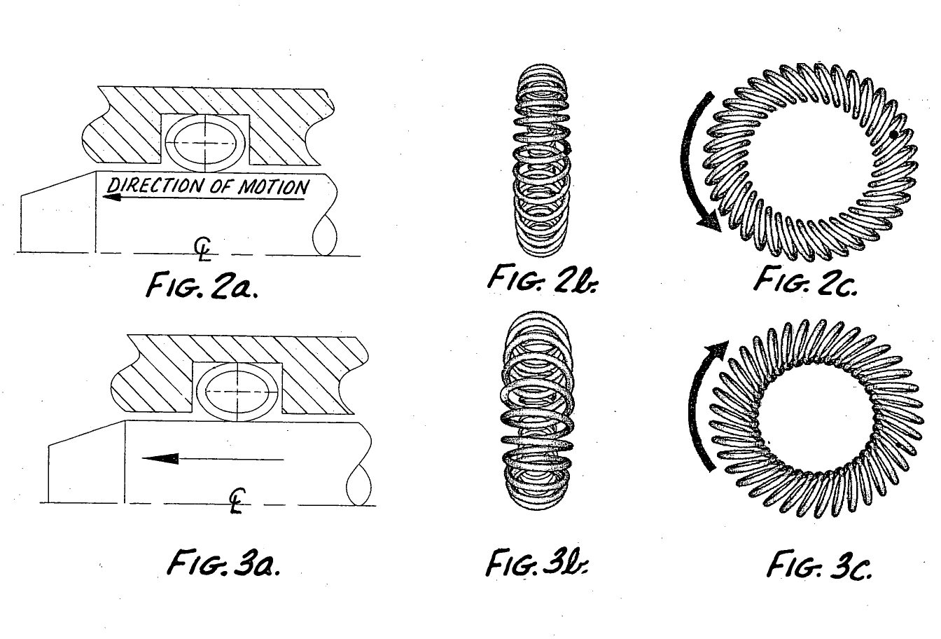

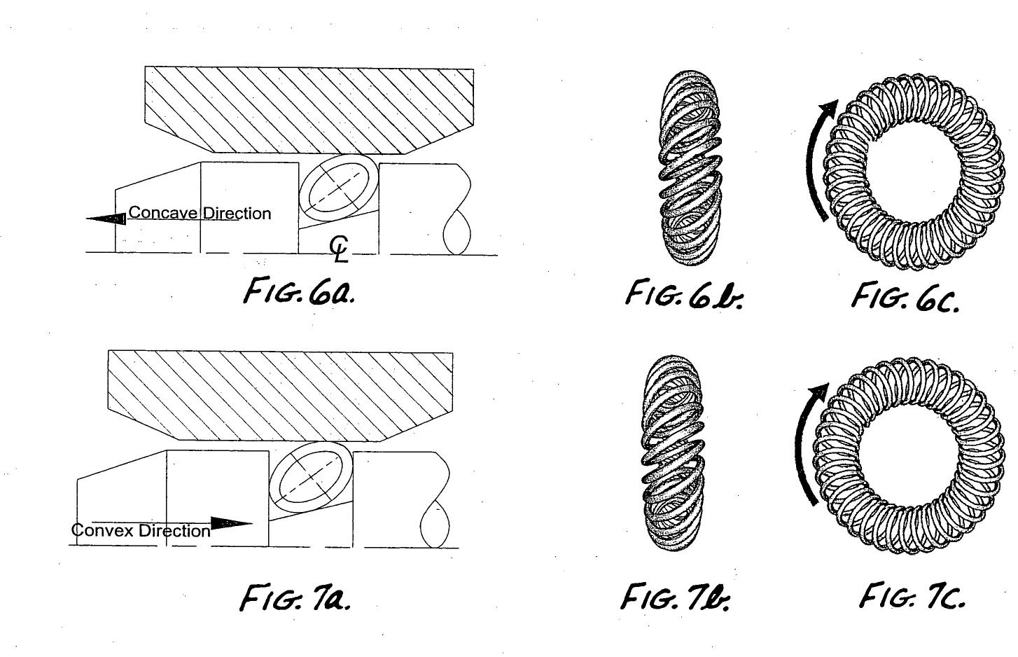

An overview or general description of spring and groove configurations as well as various definitions to enable and understanding of the present invention is appropriate. In the present application, the groove configurations have been divided into two types: one type with the spring retained in the housing see FIGS. 2a, 3a and the other with the spring retained in a shaft, see FIGS. 6a, 7a which also provides design features and characteristics of the holding connectors in accordance with the present invention.

The springs are divided in two types: a radial spring and an axial spring.

Definition of radial canted coil spring. A radial canted coil spring has its compression force perpendicular or radial to the centerline of the arc or ring.

Definition of axial canted coil spring. An axial canted coil spring has its compression force parallel or axial to the centerline of the arc or ring.

The spring can also assume various angular geometries, varying from 0 to 90 degrees and can assume a concave or a convex position in relation to the centerline of the spring.

Definition of concave and convex. For the purpose of this patent application, concave and convex are defined as follows: The position that a canted coil spring assumes when a radial or axial spring is assembled into a housing that has a groove width smaller than the coil height and upon passing a pin through the ID of such spring is either a concave or convex position. A concave position occurs when the spring is positioned by the inserting pin so that the ID is forward of the centerline of the minor axis of the spring cross section.

A convex position occurs when the spring is assembled in the piston, upon passing the piston through a housing, the spring is positioned by the housing so the OD of the spring is behind the centerline of the minor axis of the spring cross section is a convex position.

The spring-rings can also be extended for insertion into the groove or compressed into the groove. Extension of the spring consists of making the spring ID larger by stretching or gartering the ID of such spring to assume a new position when assembled into a groove or the spring can also be made larger than the groove cavity and compressed around the outside diameter to assume a smaller outside diameter to fit the groove inside diameter.

Canted coil springs are available in radial and axial applications. Generally, a radial spring is assembled so that it is loaded radially. An axial spring is generally assembled into a cavity so that the radial force is applied along the major axis of the coil, while the coils are compressed axially and deflect axially.

Radial springs. Radial springs can have the coils canting counterclockwise (FIG. 3c) or clockwise (FIG. 2c). When the coils cant counterclockwise, the front angle is in front (FIG. 2c) with the back angle in the back and when the coils cant clockwise (FIG. 3a), the back angle is in the front and the front angle is in the back. Upon inserting a pin or shaft through the inside diameter of the spring with such spring mounted in the housing in a counterclockwise position (FIG. 2c), the shaft will come in contact with the front angle of the coil and the force developed during insertion will be less than when compressing the back angle with the spring in a clockwise position. The degree of force will vary depending on various factors as hereinafter discussed. The running force will be about the same.

Radial springs may also be assembled into a cavity whose groove width is smaller than the coil height. Assembly into such cavity can be done by turning the spring coils clockwise or counterclockwise 90° and assembling the spring into the cavity. Under such conditions, the spring will assume an axial position, provided that the groove width is smaller than the coil height. Under such conditions, the insertion and running force will be slightly higher than when an axial spring is assembled into the same cavity. The reason is that upon turning the radial spring at assembly, a torsional force is created, requiring a higher insertion and running force to pass a shaft through the inside diameter or other groove configuration of the spring.

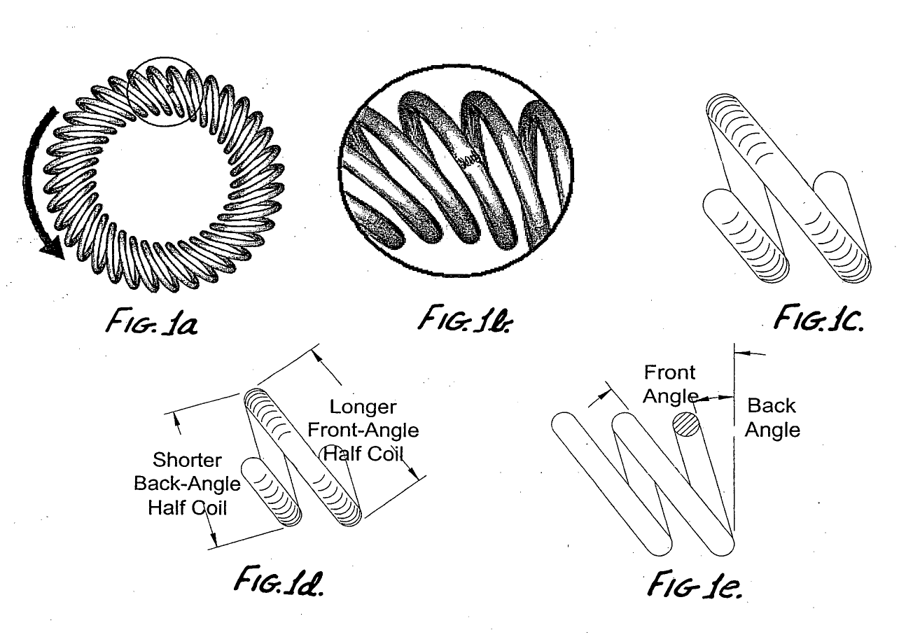

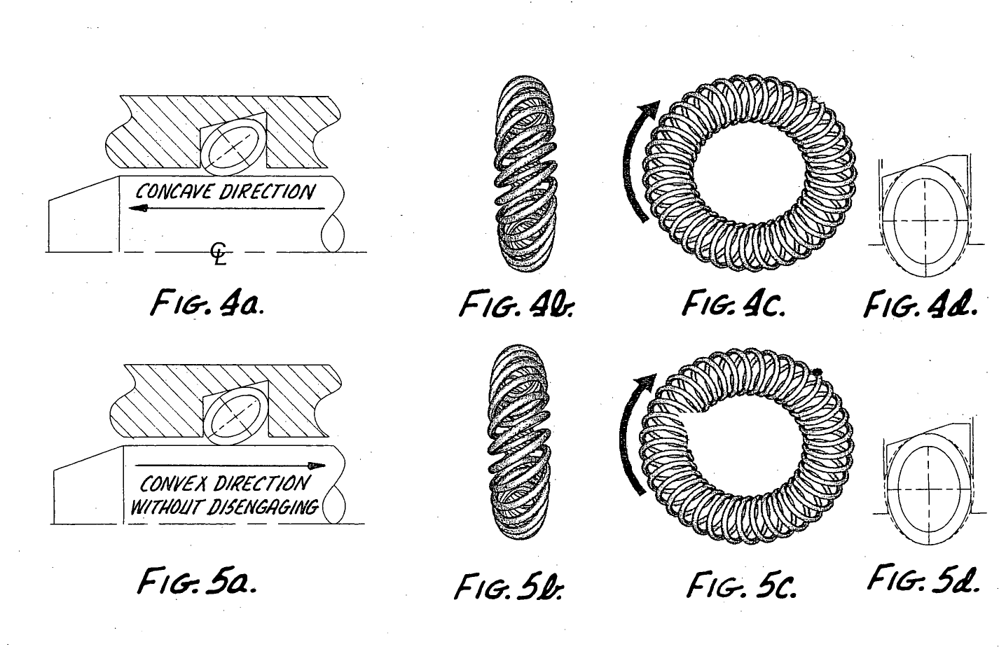

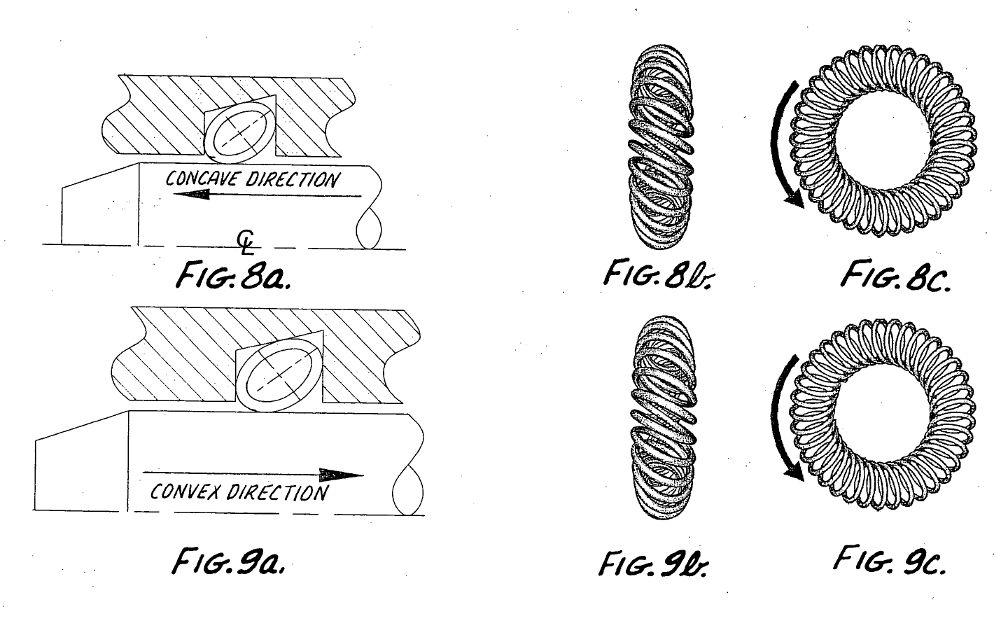

Axial springs. Axial springs can be RF (FIGS. 4c, 5c) or F (FIGS. 8c, 9c). An RF spring is defined as one in which the spring ring has the back angle (FIG. 1e) at the ID of the coils with the front angle on the OD of the coils. An F spring has the back angle at the OD and the front angle at the ID of the coils.

Turn angle ring springs. The springs can also be made with a turn angle and can assume a position from 0 to 90 degrees. It can have a concave (FIG. 4c) or a convex (FIG. 5c) position when assembled into the cavity, depending on the direction in which the insertion pin is assembled that can affect the insertion assembly and running force.

Assembly of axial spring ring into a cavity. F type axial springs always develop a higher insertion and running force than an RF spring. The reason being is that in an F spring back angle is always located at the OD of the spring, which develops a higher force.

Types of grooves. Grooves may be classified in different designs.

Flat groove. (FIG. 2a) The simplest type of groove is one that has a flat groove and the groove width is larger than the coil width of the spring. In such case, the force is applied radially.

‘V’ bottom groove. This type of groove retains the spring better in the cavity by reducing axial movement, increasing the points of contact, which enhances electrical conductivity and reduces the variability of such conductivity. The groove width is larger than the coil width. The spring force is applied radially.

Grooves for axial springs. Grooves for axial springs are designed to better retain the spring at assembly. In such cases, the groove width is smaller than the coil height. At assembly, the spring is compressed along the minor axis axially and upon the insertion of a pin or shaft through the ID of the spring the spring, the coils deflect along the minor axis axially.

There are variations of such type of grooves from a flat bottom groove to a tapered bottom groove or modifications thereof.

Axial springs using flat bottom groove. In such cases, the degree of deflection available on the spring is reduced compared to a radial spring, depending on the interference that occurs between the coil height and the groove width.

The greater the interference between the spring coil height and the groove, the lower the spring deflection and the higher the force to deflect the coils and the higher the insertion and running forces on shaft/pin insertion.

In such cases, the spring is loaded radially upon passing a plunger through the ID of such spring and the deflection occurs by turning the spring angularly in the direction of movement of the pin. An excessive amount of radial deflection may cause permanent damage to the spring because the spring coils have “no place to go” and butt.

Axial springs with grooves with a tapered bottom. A tapered bottom groove has the advantage that permits the spring to deflect gradually compared to a flat bottom groove. When a pin is passed through the ID of the spring while such spring is mounted in the groove, it will deflect in the direction of motion and the running force may remain about the same or vary depending on the direction of the pin and the type of spring. Lower force will occur when the pin moves in a concave spring position (FIG. 16b) and higher force (FIG. 17b) that when the pin moves in a convex spring position.

Tapered bottom grooves have the advantages that they have a substantial degree of deflection, which occurs by compressing the spring along the minor axis, thus allowing for a great degree of tolerance variation as compared to flat bottom grooves.

Grooves can be mounted in the piston or in the housing, depending on the application. Piston mounted grooves are shown in FIG. 6a, 7a.

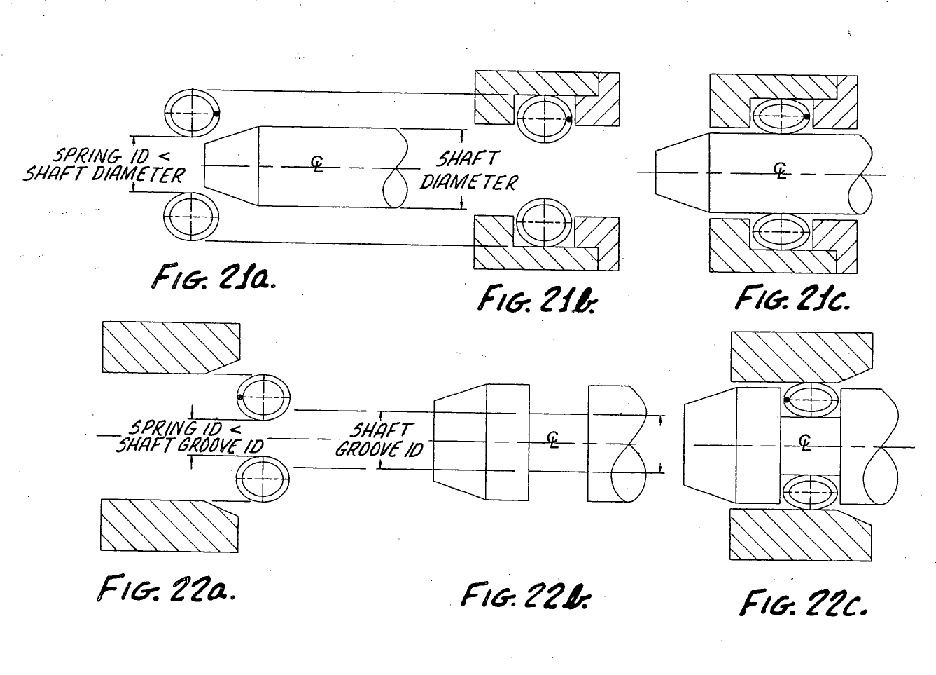

Expanding a radial spring or compressing such spring. A radial spring ring can be expanded (FIG. 21a, 21b, and 21c) from a small inside diameter to a larger inside diameter and can also be compressed from a larger OD to a smaller OD (FIGS. 23a, 23b, and 23c) by crowding the OD of such spring into the same cavity. When expanding a spring ring, the back angle and front angles of the spring coils decrease (See FIGS. 1a to 1e), thus increasing the connecting and running force. When compressing a radial spring OD into a cavity, which is smaller than the OD of such spring, the coils are deflected radially, causing the back and front angles to increase. The increase of such angles reduces the connect and running force when passing a pin through the ID of such spring.

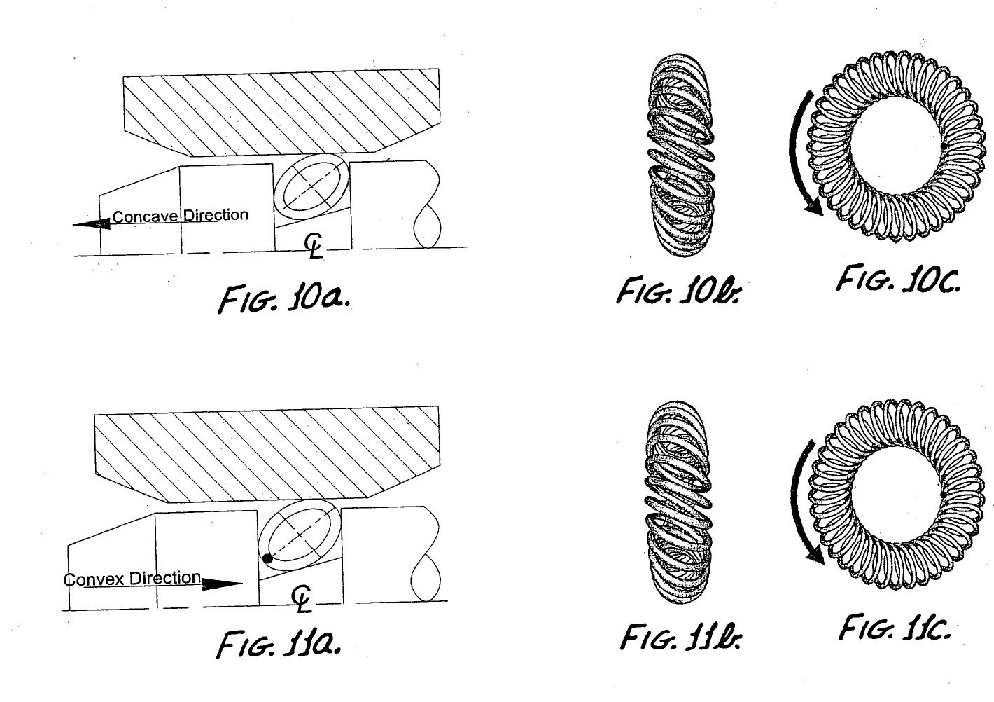

The following designs are incorporated into the present patent application by this specific reference thereto as follows:
1) U.S. Pat. No. 4,893,795 sheet 2 FIGS. 4, 5A, 5B, 5C, 5D, 5E, 6A and 6B;
2) U.S. Pat. No. 4,876,781 sheet 2 and sheet 3 FIGS. 5A, 5B, and FIG. 6.
3) U.S. Pat. No. 4,974,821 page 3 FIGS. 8 and 9
4) U.S. Pat. No. 5,108,078 sheet 1 FIGS. 1 through 6
5) U.S. Pat. No. 5,139,243 page 1 and 2 FIGS. 1A, 1B, 2A, 2B and also FIG. 4A, 4B, 5A, and 5E
6) U.S. Pat. No. 5,139,276 sheet 3 FIGS. 10A, 10B, 10C, 11A, 11B, 12A, 12B, 12C, 13A, 13B, and 14
7) U.S. Pat. No. 5,082,390 sheet 2 and 3, FIGS. 4A, 4B, 5A, 5B, 6A, 6B, 7A, 7C, 8A, 8B
8) U.S. Pat. No. 5,091,606 sheets 11, 12, and 14. FIGS. 42, 43, 44, 45, 46, 47, 48, 48A, 48B, 49, 50A, 50B, 50C, 51A, 51B, 51C, 58A, 58B, 58C, 58D.
9) U.S. Pat. No. 5,545,842 sheets 1, 2, 3, and 5. FIGS. 1, 4, 6, 9, 13, 14, 19, 26A, 26B, 27A, 27B, 28A, 28B.
10) U.S. Pat. No. 5,411,348 sheets 2, 3, 4, 5, and 6. FIGS. 5A, 5C, 6A, 6C, 7A, 7C, 7D, 8A, 8B, 8C, 9A, 9C, 10C, 11, 12 and 17.
11) U.S. Pat. No. 5,615,870 Sheets 1-15, Sheets 17-23 with FIGS. 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 66, 67, 68, 69, 70, 71, 72, 73, 74, 75, 76, 77, 78, 79, 80, 81, 82, 83, 84, 85, 86, 87, 88, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 123, 124, 125, 126, 127, 128, 129, 130, 131, 132, 133, 134, 135.
12) U.S. Pat. No. 5,791,638 Sheets 1, 2, 3, 4, 5, 6, 7, 8, 9, 10, 11, 12, 13, 14, 15, 17, 18, 19, 20, 21, 22, 23. FIGS. 1-61 and 66-88 and 92-135.
13) U.S. Pat. No. 5,709,371, page 1, 2, 3, 4, 5, 6, 7, 8, 9, 10, 11, 12, 13, 14, 15, 17, 18, 19, 20, 21, 22, 23. FIGS. 1-61 and 66-88 and 92-135.

### DETAILED DESCRIPTION

Axial springs consist of RF and F springs.

RF springs have e coils canting clockwise with the back angle at the ID and the front angle at the O.D.

F springs have coils canting counterclockwise and the back angle on the OD and the front angle on the ID.

FIGS. 1-37 provide a greater detailed data on the different groove configurations, different types of springs, running forces and background information on the different features of connectors, force parameters, and unique features of such connectors as related to this patent application.

FIGS. 1a, 1b, 1c, 1d, and 1e, show a description of the front and back angles of the canted coil spring with the following features.

A canted coil spring consists of two halves. One-half is the shorter back angle half of the coil and the other is the longer front angle half coil. The front angle half is longer (See FIG. 1d) and its lever arm is larger (1e), thus less force is needed to deflect such spring compared to the back angle half coil.

FIGS. 1a, 1b, 1c, 1d, and 1e describe the different positions of a radial spring and the front and back angle.

FIG. 1

Definitions as Applied to the Present Application:

(A) Shaft connecting-insertion force is the force required to insert the chamfer part of the shaft through the ID of the spring until the ID makes contact with the body of the shaft where the diameter is constant. (See FIGS. 2c, 3c)
(B) Housing connecting insertion force is the force required to insert the piston through the chamfer portion of the housing.
(C) Running force is the force of the shaft is the force required to move the body of the shaft (constant diameter part) through the ID of the spring after it has been connected.
(D) Running force of the piston is the force required to move the piston through the bore (constant diameter part)

Radial springs. Radial springs are divided into clockwise and counterclockwise springs.

Counterclockwise spring has the front angle in the front. The weld reference point is also in the front angle facing the incoming motion of the shaft. In the case of a housing, the counterclockwise front angle is in the back of the coil.

Counterclockwise radial spring is the same as a clockwise radial spring except that it is turned 180°. The running force of a radial spring mounted on a flat bottom groove canting clockwise or counterclockwise is about the same. Counterclockwise radial springs are described in FIG. 2a, FIG. 2b, and FIG. 2c.

FIG. 2 Counterclockwise Radial Spring in Flat Bottom Housing Groove

Counterclockwise radial springs are described in FIG. 2a, FIG. 2b, and FIG. 2c.

The front angle is in the front facing the incoming motion of the shaft. In the case of the piston the back angle faces the incoming motion of the piston.

The running force developed when the shaft travels against radial springs mounted counterclockwise (FIG. 2c), similar to the running force developed when the shaft travels against radial springs mounted clockwise (FIG. 3c)

FIG. 3. Clockwise Radial Spring and Flat Bottom Housing Groove, Front Angle in the Back.

Features

The back angle is in the front, the weld referenced point is in the back facing away from the incoming motion of the shaft or bore. A clockwise radial spring is the same as a counterclockwise radial spring except that it is turned 180°. The running force of a radial spring mounted in a flat bottom housing groove canting clockwise or counterclockwise is about the same.

FIGS. 3a, 3b, and 3c describe a clockwise radial spring and mounting means in a flat bottom groove.

There is no significant variation in running force when moving the shaft with the spring mounted in a counterclockwise or clockwise position.

FIG. 4 shows a RF clockwise axial spring in a tapered bottom groove. The shaft travels forward in a concave position as shown in FIG. 4c direction in respect to the ID of the spring.

FIG. 5 shows an RF spring clockwise axial spring mounted in a tapered bottom groove, housing groove, shaft travels backward in the convex direction. Direction with respect to the spring ID.

Comparing FIGS. 4a, 4b, 4c, and 4d with 5a, 5b, 5c, and 5d shows that the running force in a concave direction and the running force in a convex direction is approximately the same.

FIGS. 6 and 7 shows the same type of design (FIG. 6c and FIG. 7c) with the spring mounted in a piston. The results are in essence the same, that is, the running force in a concave direction is essentially the same as the convex direction running backwards using an RF spring with the results being similar to those indicated when the spring is mounted in the housing.

FIGS. 8 and 9 make a comparison similar to those indicated in FIG. 4 and 5 but in this case an F axial spring is being used. The results show that when an F spring is mounted in a housing and the concave and convex direction is measured, going forward and back, the convex direction develops approximately 7% greater force than the concave direction, indicating that the F springs with lower deflection and higher force per unit deflection develops a higher differential running force than an equivalent RF spring by approximately 18% to 25%.

FIGS. 10 and 11 shows an F spring mounted in a piston and the results also indicate that when a F spring is mounted in a piston and moved forward in a concave direction, it develops lower force than when moving the same piston backwards in a convex direction. The variation is approximately 7% with a convex movement developing higher force.

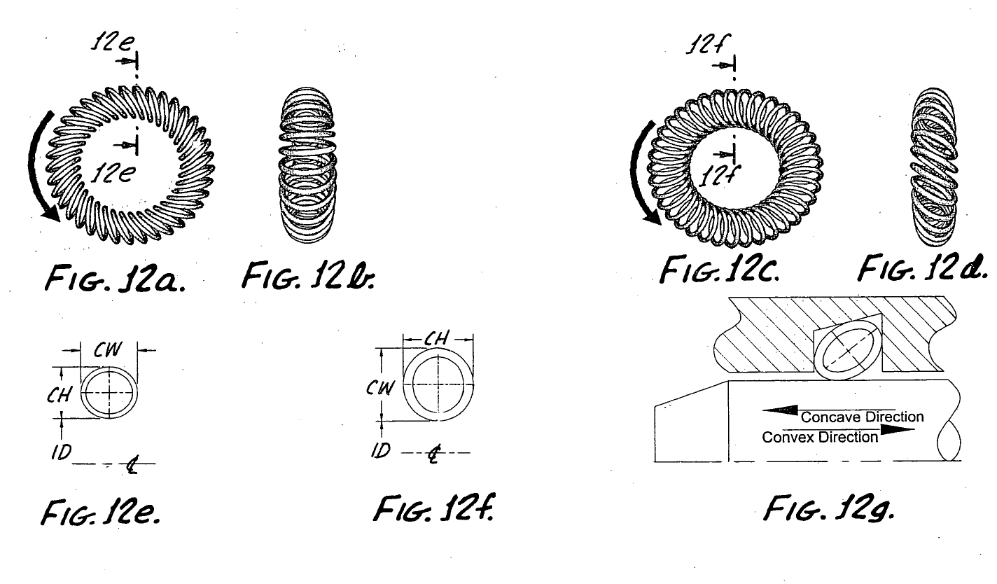

FIG. 12. Counterclockwise radial spring turned 90° counterclockwise into a counterclockwise axial F spring and assembled in a groove with groove width smaller than the coil height. This is described in FIGS. 12a through 12g. Comparing an axial spring as indicated in FIGS. 8a, 8b, and 8c and compared to that of 12a through 12g shows that when a radial spring has been turned 90° into an axial spring and assembled into a groove, the coils have higher stress level compared to an axial F spring in the same groove. This added stress develops higher running force.

Another factor that affects running force is when the shaft travels in a concave direction. The friction between the shaft and spring turns the spring clockwise, opposing the natural tendency of the spring as its torsional force tries to return the spring to its built-in radial position by turning counterclockwise. The combination of pre-stress torsional force direction and position of the back angle at the OD gives this design 12-c about 10 to 30 percent higher running force compared to the design in FIG. 8c.

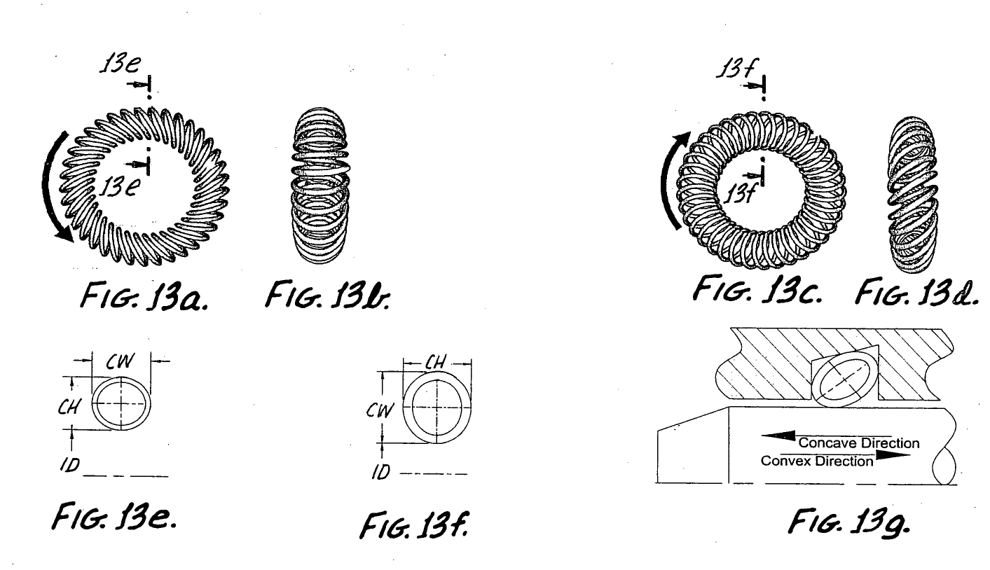

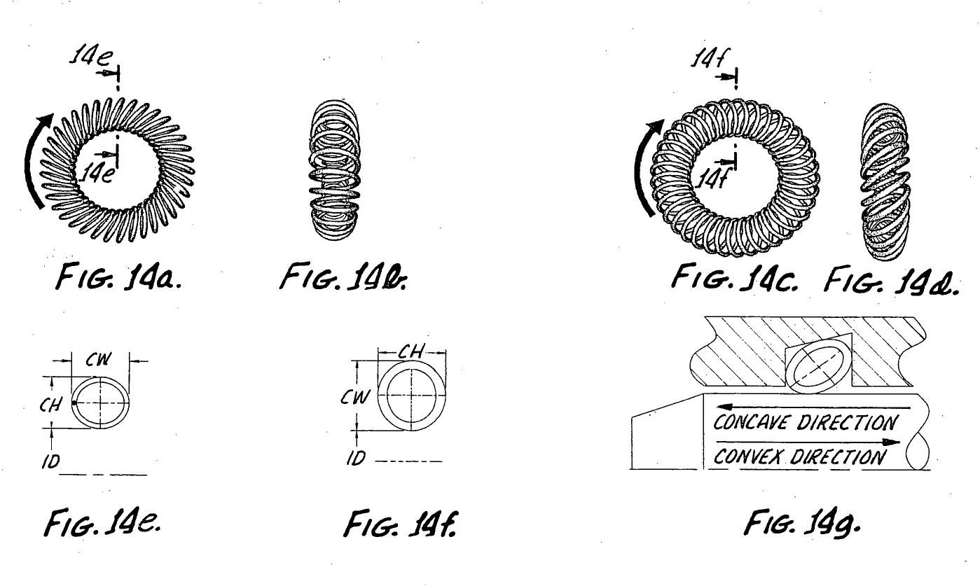

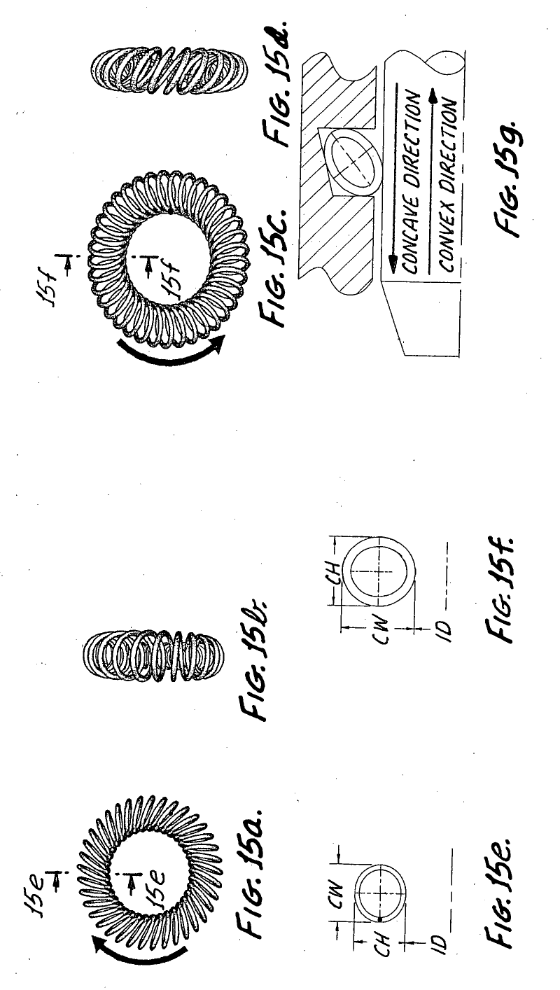

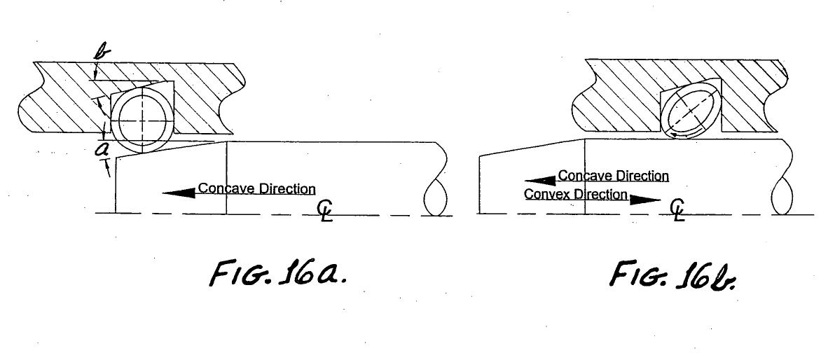

FIG. 13. Counterclockwise radial spring turned 90° clockwise into a clockwise axial RF spring assembled in a groove with a groove width smaller than the coil height.

FIGS. 13a through 13g describe this spring. It has been turned from a radial counterclockwise spring into an axial RF spring. Comparing 13g to 4c it shows that when a radial spring has been turned 90° into an axial spring and assembled into a groove, the coils have a higher stress level compared to an axial RF spring in the same groove. This added stress develops higher running force. Another factor that affects the running force is when the shaft travels in a concave direction. The friction between the shaft and spring turns the spring clockwise, assisting the natural tendency of the spring as its torsional force tries to return the spring to its built-in radial position by turning clockwise. The combination of pre-stress torsional force direction and position of the back angle at the ID gives the design 13c about 10 to 20 percent higher running force compared to the design in FIG. 4c.

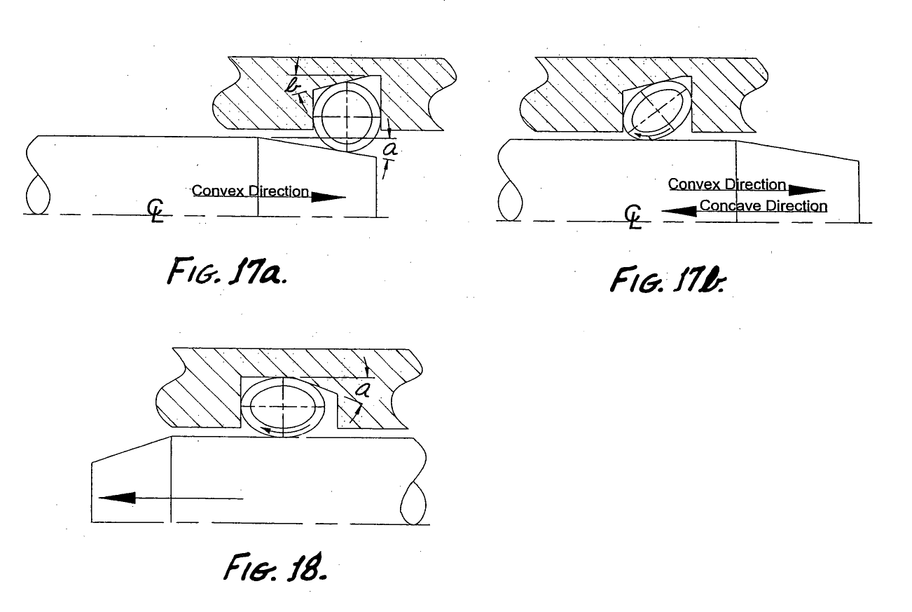

FIG. 14. Clockwise radial spring turned 90° counterclockwise into a clockwise axial RF spring and assembled in a groove with a groove width smaller than the coil height. Comparing FIGS. 14g with 4c it shows that the combination of pre-stress torsional force and position of the back angle at the ID gives this design 14g about 10 to 20 percent higher running force compared to the design in 4c.

FIG. 15 clockwise radial spring turned 90° clockwise into a counterclockwise axial F spring and assembled in a groove with groove width smaller than the coil height. FIGS. 15a through 15g describe this type of spring and when we compare FIG. 15g to 8c it shows that the combination of pre-stress torsional force direction and position of the back angle at the OD gives this design (FIG. 15c) about 10 to 30 percent higher running force compared to the design in FIG. 8c.

FIG. 16 and FIG. 17.

FIG. 16. Axial RF and F springs show a shaft moving in the concave direction of the spring ID as shown in FIGS. 16a and FIG. 16b and FIG. 17 showing an axial RF and F spring shaft moves in the convex direction of the spring ID as shown in FIG. 17a and FIG. 17b. In this case, a comparison has been made between the direction of motion in a concave direction as indicated in FIG. 16a and 16b with that of FIG. 17a and 17b. The results show that for both RF and F springs when the pin or shaft moves in a concave direction it provides substantially lower force than when the same pin is turned around 180° and move the pin in a convex direction with the RF springs developing substantially lower force than the F springs. See Table 1 for results.

The unexpected results show as follows:

RF spring. Running Force. The running force of the shaft traveling in the convex direction is 304% higher than the running force of the shaft traveling in the concave direction.

F spring. Running Force: The running force of the shaft traveling in the convex direction is 1233% higher than the running force of the shaft traveling in the concave direction.

Conclusion:

The running force difference between the shaft traveling in the concave and convex direction is substantial. When the shaft travels in the convex direction, the insertion and running forces are higher in both RF and F axial springs. In RF springs the increase in running force was 304%. In F spring the increase was 1233%.

The substantially higher force when the shaft is inserted and traveled in the convex direction occurs because during insertion, the shaft's chamfer turns the spring clockwise, as the spring turns clockwise, the point of contact between the shaft and the spring moves closer to the centerline of the major axis where no spring deflection is possible. Large amount of force is required to force the chamfer part of the shaft to pass the spring. After the shaft has been inserted and the spring has wedged against the shaft, the shaft continues to travel in the same direction, the friction between the spring and the shaft turns the spring clockwise opposing the natural tendency of the spring as it tries to deflect. The action keeps the spring in the wedged position and therefore a large amount of force is required for the shaft to travel in the convex position after it has been inserted in the same direction (FIG. 17a and FIG. 17b).

The ‘F’ springs in the convex direction produces substantially higher running force 1233% than ‘F’ springs in the concave direction. In ‘RF’ springs, the running force in the convex direction is 304% higher than in the concave direction.

Values vary depending on various parameters such as groove dimensions, spring dimensions and piston/shaft dimensions, etc.

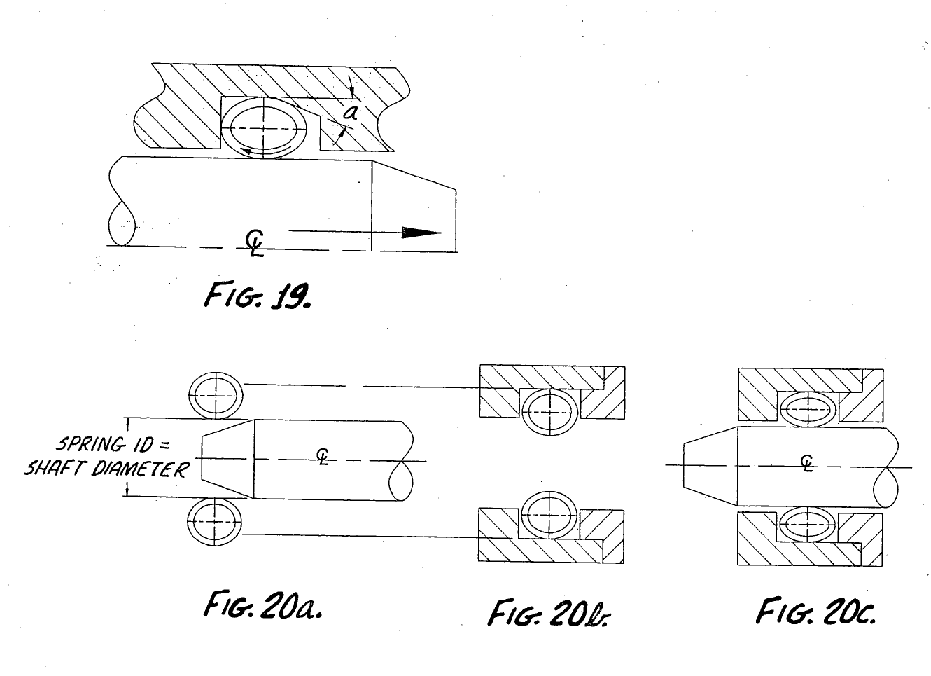

FIGS. 18 and 19. Reviewing FIGS. 18 and 19 when the pin moves away from a turn angle ‘a’ the running force developed is substantially less than when the pin moves towards the tapered angle ‘a’. In both cases, the spring turns clockwise.

FIGS. 20 and 21. Radial springs. OD of radial spring is larger than the ID of the housing spring mounted in the housing. This is described in FIGS. 20a, 20b, and 20c in which it shows that the OD of the spring is larger than the ID of the cavity in which such spring is to fit. Compressing the spring from the OD results in an increase in the back and front angles of the coil and thus reducing the insertion and running forces.

FIG. 21 radial spring. OD of radial spring is the same as the OD of the housing spring mounted in the housing.

FIGS. 21a, 21b, and 21c shows that the ID of the spring is smaller than the shaft diameter, thus requiring stretching of the spring. In stretching the spring from the ID results in a decrease in the front and back angle, resulting in higher insertion and running frictional forces.

Table 2 makes a comparison between springs having different springs ID and OD and assembled into the same cavity having the same shaft and same housing. The results shows that the stretching the spring from the ID results in higher running force. Compressing the spring from the OD results in lower running force.

FIG. 22. Radial spring. Spring mounted on the piston, spring ID is smaller than the piston groove diameter indicated in FIGS. 22a and 22b. In this case, by stretching the spring to mount in a groove or piston results in higher running force.

FIG. 23. Radial spring. Spring mounted on the piston. Spring ID is equal to the piston groove diameter.

FIG. 23a, FIG. 23b, and FIG. 23c. In this case, the spring ID is equal to the piston groove diameter but the spring OD is larger than the housing diameter. The results show that by compressing the coils from the OD of the spring it increases the front and back angles, resulting in lower breakout and running forces.

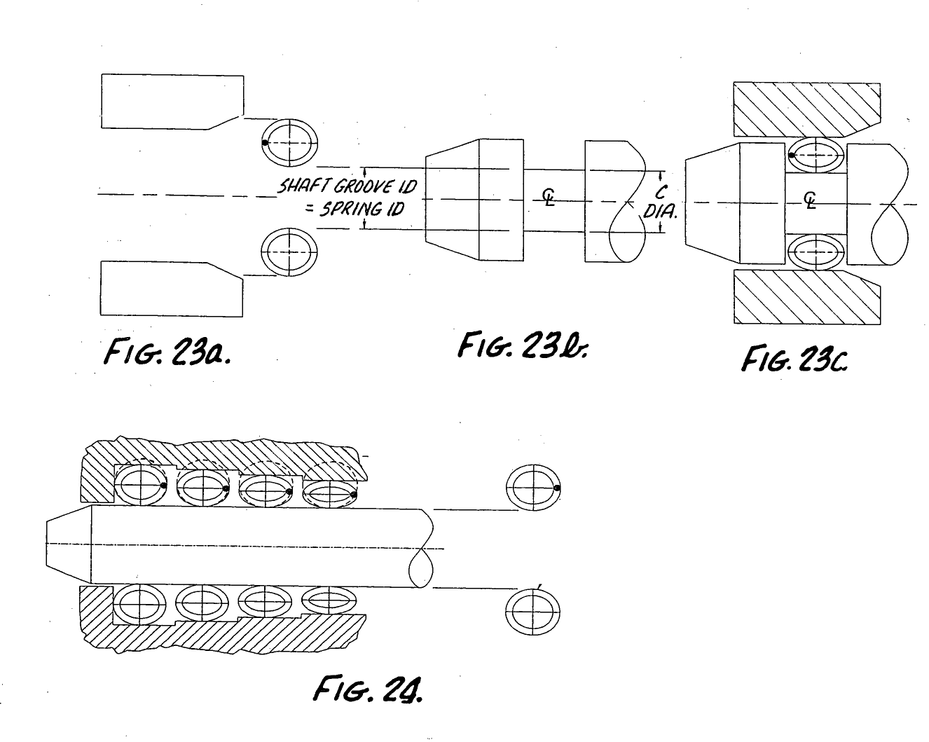

FIG. 24. Same shaft diameter, same spring diameter, varying housing bore diameter. This is indicated in FIG. 24 in which it shows an assembly with the same shaft diameter and the same spring with different housing diameters. Compressing the spring coils from the OD results in lower running frictional forces than compressing the coils from the ID. The reason being is that when compressing the coil from the OD it increases the front and back angle, decreasing the force required to pass a plunger through such spring ID.

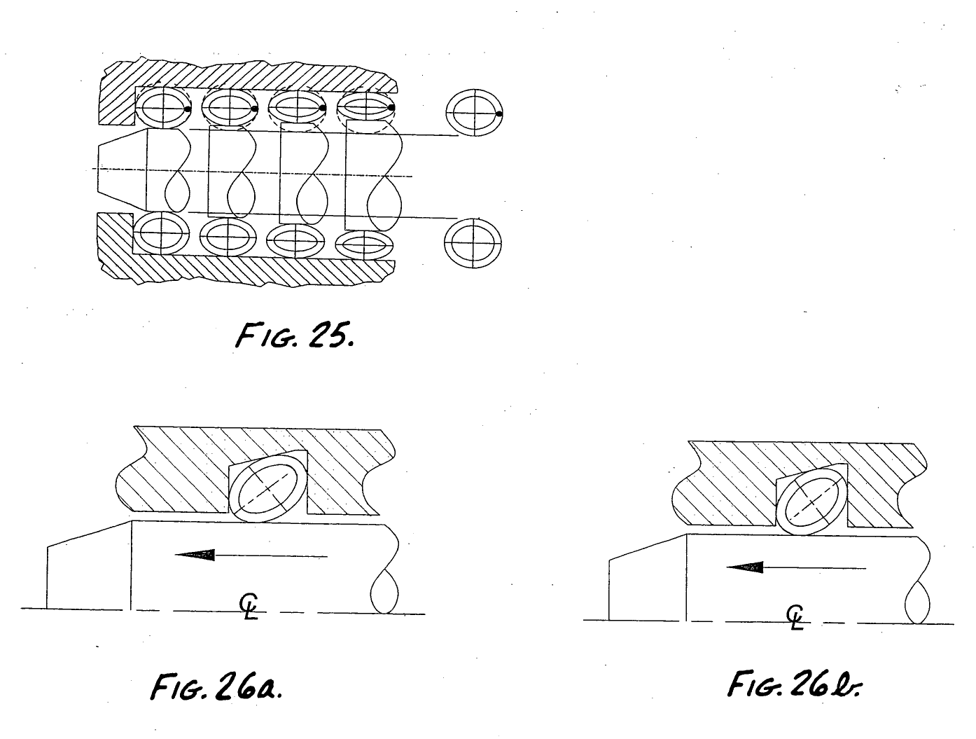

FIG. 25. Same housing bore diameter, same spring diameter, bearing shaft diameter. FIG. 25 shows an assembly having a constant bore diameter, a constant spring diameter, and a variable shaft diameter. The results, as indicated, in Table 3 comparing the running force of a spring compressed from the OD at various deflections shows that compressing the coils from the OD while maintaining the same spring and shaft diameter results in lower running force.

Table 4 compares running force of a spring compressed from the ID at various deflections and it shows that stretching the spring ID to the shaft diameter and compressing the coils from the ID results in higher running force. Stretching the spring increases the deflection before butting.

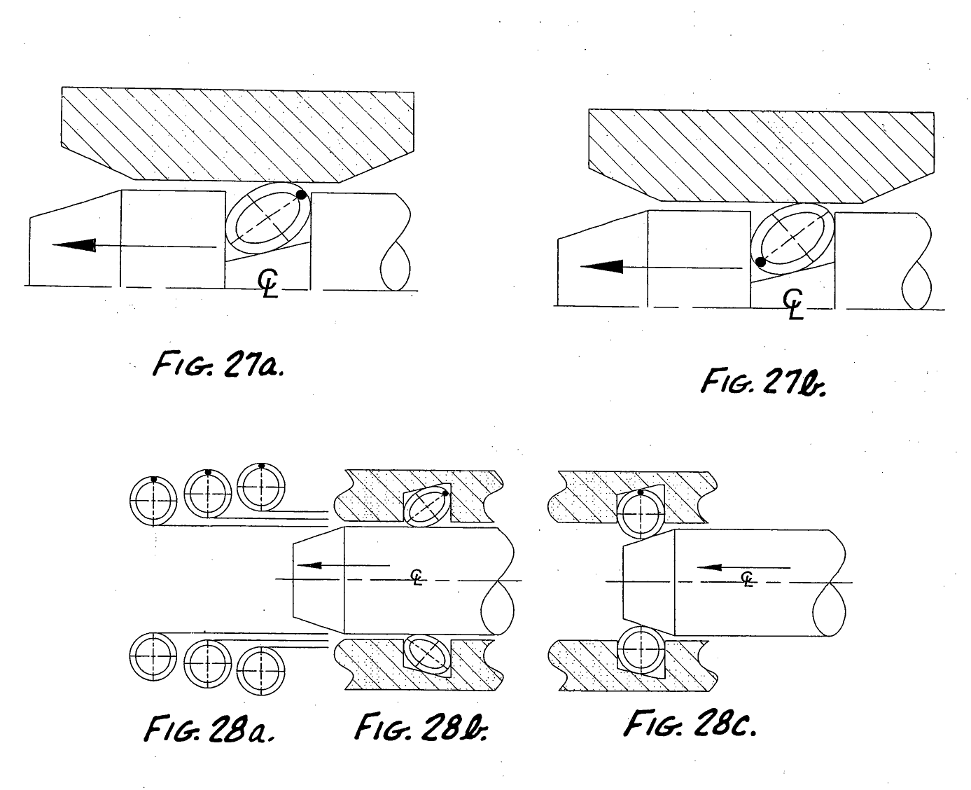

FIG. 26. F spring vs. RF spring mounted in a housing. FIG. 26a and FIG. 26b makes a comparison between an RF spring mounted in the same housing versus an F spring mounted in the same housing. The RF spring has the front angle on the OD while the F spring has a front angle at the ID. The results, as indicated in Table 5 shows that RF springs develop 10 to 20 percent lower running force than F springs under the same conditions.

The results show then that an F series spring develops higher running force than RF series. The average running force of the RF springs is 10% to 20% lower compared to the average running force of the F spring, depending on the spring series. Table 5 compares the running force of F springs mounted in a housing. RF springs develop 10 to 20 percent lower running force than F springs under the same conditions. Table 5 shows a variation of approximately 10% lower for the RF springs. Values vary substantially with the spring and groove parameters.

FIG. 27. F Spring Versus RF Spring Mounted on a Piston

FIG. 27a shows a RF spring mounted on a tapered bottom piston with the front angle at the OD and the back angle at the ID.

FIG. 27b shows the same type of design except that in this case, an F spring is shown with the front angle at the ID and the back angle at the OD. The spring is assembled in the cavity having a groove width smaller than the coil height and assuming a vertical position. Upon assembling the piston into the housing, the spring assumes a concave position, and the running force of the RF spring is lower than the force of the F spring, changing from approximately 10% to 30% lower. Table 6 shows a variation of approximately 16% lower for the RF springs. Values vary substantially with the spring and groove parameters.

FIG. 28 Shows a Variation of the RF Spring Diameter and its Effect on Forces.

FIG. 28a shows axial springs of different diameters with the smaller diameter equal to the shaft diameter. Other springs having a larger ID when assembled into the housing whose groove width is smaller than the coil height. Upon assembling such springs into the same cavity, as indicated in FIG. 28c, the spring coils assume a position as indicated in FIG. 28f, and the springs having a larger inside diameter and a larger outside diameter and therefore more coils per spring, when compressed radially by reducing the outside diameter, causes the back angle and front angle to increase, decreasing the force required to pass a plunger through the ID of such spring. The results, as indicated in Table 7 Axial RF Spring Versus Running Force, show that the larger diameter springs with more coils develop lower force than the springs with fewer number of coils and having a smaller inside and outside diameter. The variation can range anywhere from 10 to 30 percent or more depending on spring and groove parameter.

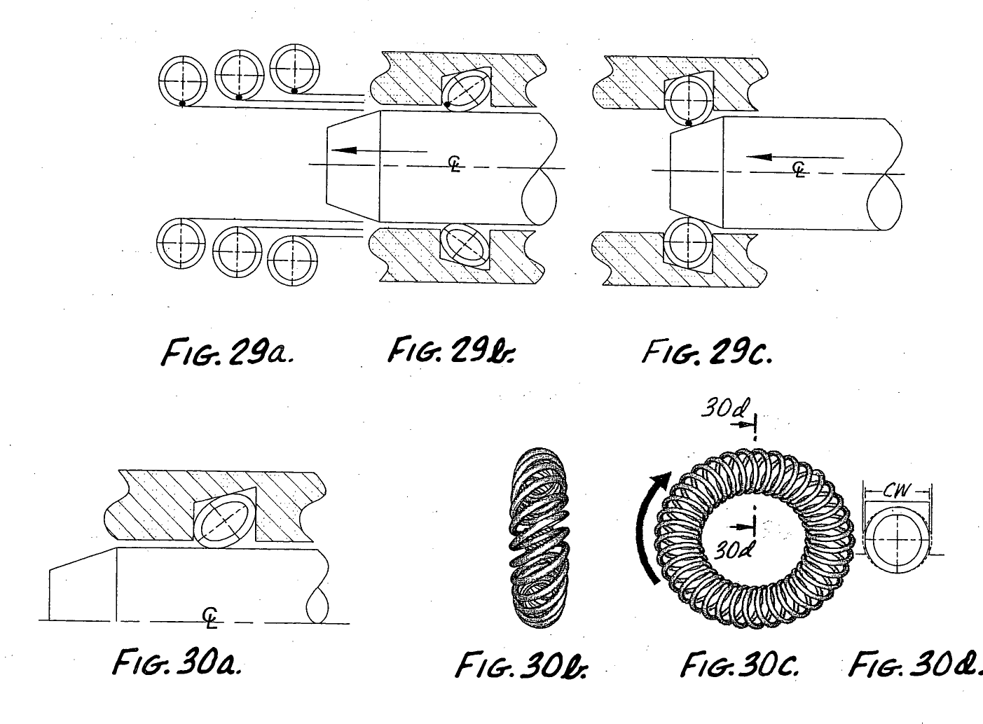

FIG. 29 Compares the Variation of an F Spring Diameter and its Effect on Force.

FIG. 29a, 29b, and 29c are the same as in FIG. 28, except that an F spring instead of an RF spring is being used; the F spring having the front angle at the ID and the back angle at the OD. The results, as indicated in Table 8, show that the springs with the larger outside diameter and thus a larger number of coils when compressed into a housing, as indicated in FIG. 29b, show that the larger diameter springs when the pin is passed through the ID of such spring develop a substantially lower force than the smaller diameter springs, as indicated in Table 8. The variation ranges from approximately 10 to 30 percent and such variations depend on groove and spring considerations.

Comparing the running forces between the RF and F springs indicated in FIGS. 28b and 29b as recorded in Table 9 and 11, it shows that F springs under the same conditions develop higher running forces than RF springs.

FIGS. 30 to 37 shows different kinds of groove spring configurations having a flat bottom groove, both on the housing and in the piston using axial springs in a groove whose groove width is smaller than the coil height.

FIG. 30 and 31 makes a comparison between the force developed when passing a pin in a concave and a convex direction. In this case, when using an RF spring, the running force back and forth is essentially the same in both cases.

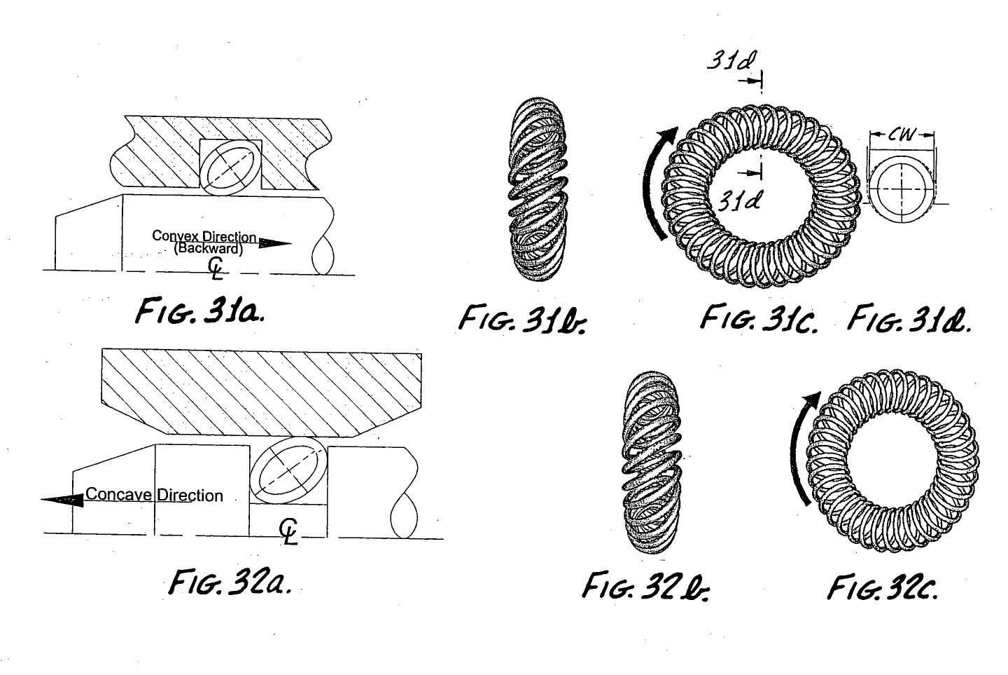

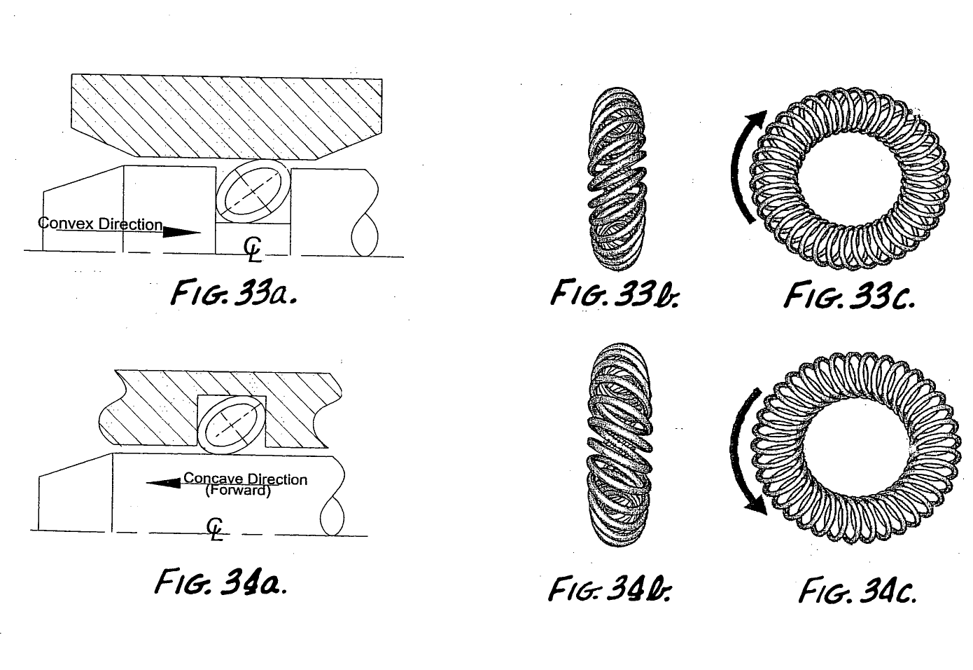

FIG. 32 and 33 shows design where the spring is mounted in a piston groove with the front angle on the OD and the back angle on the ID. In this case, the springs are also positioned in a concave position and when moving the pin in a concave direction or in a convex direction, the running force is essentially the same in one direction or the other.

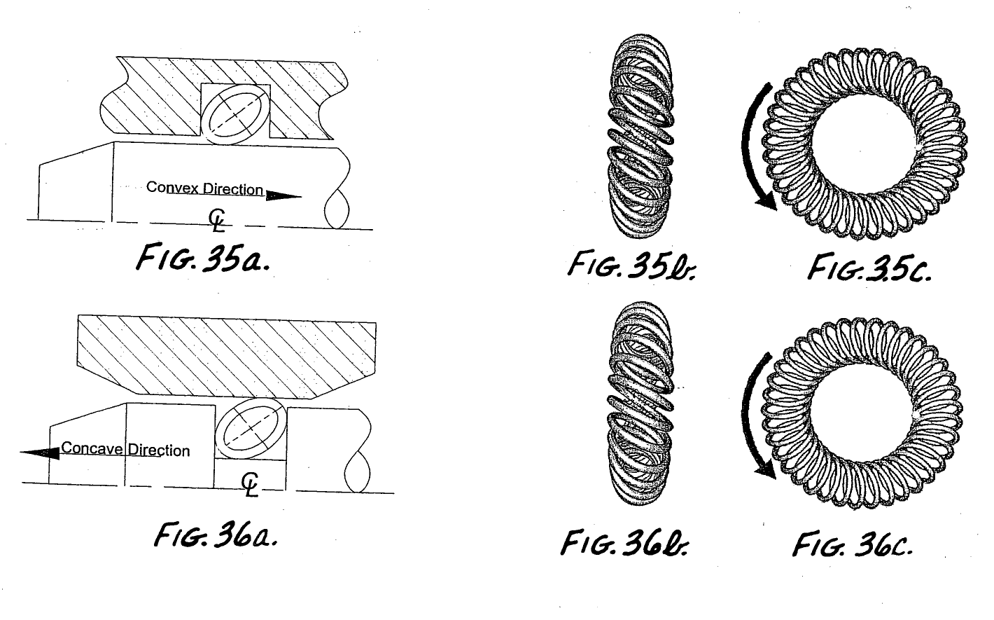

FIG. 34 and 35 shows an F spring mounted in a housing and the pin moving in a concave direction and also in a convex direction. In this case, when the pin is moved in a convex direction, the running force with the F type spring runs approximately 10 to 30 percent higher than when running in a concave direction. The variation depends on the groove configuration and spring design.

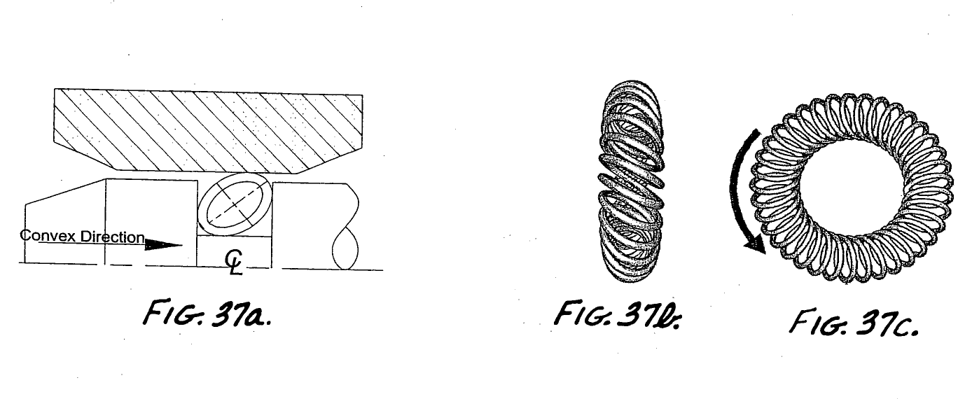

FIG. 36 and 37 also makes a comparison between a F spring mounted in a piston groove and the pin moving in a concave or convex direction. When the pin is moved in a convex direction, the frictional force developed is anywhere from 10 to 30 percent higher than when moving in a concave direction.

A review of the results indicated in FIGS. 30 to 37 indicates that when using the RF spring, having a front angle on the OD and the back angle on the ID, the force versus deflection remains much more constant than when using an F spring that has substantially lower deflection and a higher force versus deflection; thus, a small amount of deflection results in a substantially higher force and is represented by the values indicated, whereby when using the F spring the insertion and running forces are substantially higher than those obtained with an RF spring.

The springs herein shown illustrate circular springs that can radial, axial or turn angle, that can be joined in various ways, primarily by bringing the ends together by welding, thus forming a circle. However, such springs can also be held together in many other ways and still permit the operational requirements as indicated.

The springs can be mounted in a housing groove or can be mounted in a piston groove and the springs can be radial and mounted radially; can be radial and mounted axially and can be axial and mounted axially and the springs can also be turn angle and they can be mounted radially or axially.

Housing mounted springs. The housing mounted springs can be assembled into a groove in the following manner.

1. By making the length of the spring longer than the length of the circumference that the groove in which it is to fit so that the ends of the spring can be encased into the ends of such coils in a radial, axial or turn angle manner.
2. By making the length of the spring slightly longer than the length of the circumference of the groove so that upon assembling into the housing the ends of the spring will come in contact with each other, due to the longer length of the spring over the length of the cavity.
3. By making the length of the spring shorter than the length of the circumference of the groove in which it is to fit in so that upon assembly there will be a gap between the ends of the coils, once assembled into the cavity.

Piston mounted springs. The piston mounted springs will be made in a similar manner as the ones that are mounted in the housing as follows:
1. Making the length of the spring larger than the internal groove length of the cavity so that the ends of the coils are encased into each other, be radial or axial or turn angle.
2. By making the length of the spring slightly larger than the length of the circumference of the piston groove so that upon assembly, the ends of the coil will be butting against each other.
3. By making the length of the spring smaller than the length of the circumference of the piston groove so that upon assembly there will be a gap between the coils.

The springs can be radial and upon assembly, they can cant clockwise or counterclockwise. The springs can also be axial whereby upon assembly they will be RF with a front angle on the OD or F with the front angle on the ID.

The length of the springs can be assembled in the housing or in the piston as indicated in U.S. Pat. No. 5,709,371, U.S. Pat. No. 5,791,638 and U.S. Pat. No. 5,615,870 all to Bal Seal.

The conductivity/resistivity and the variability of the current passing from the housing to the shaft through the spring or vice versa is affected by various parameters, which are as follows:

The method of mounting the spring in the housing, be it a radial or axial spring. An axial spring or a radial spring mounted axially will develop higher stress on the shaft than an equivalent radial spring.

An F spring will develop a higher stress on the shaft than an equivalent RF spring.

The smaller the ratio of the spring ID to the coil height, the higher the stress acting on the coils at the ID and the higher the stress acting on the shaft.

The smaller the ratio of the spring ID to the ratio of the coil height to wire diameter, the higher the stress acting on the coils at the ID and the higher the stress acting on the shaft. The resistivity and conductivity is affected to a certain extent by the stress in pounds per square inch acting on the shaft. Such stress is not linear, meaning that after a certain amount of stress an increase in stress does not result in an increase in conductivity. However, the variability of the resistivity is reduced by higher stress acting on the shaft. The higher the eccentricity and angular misalignment, the higher the variability that can occur. Therefore, the most desirable condition occurs when we obtain maximum deflection of the spring coils as well as adequate stress of those coils. The higher deflection of the spring at the ID of such spring will permit a higher degree of eccentricity, angular misalignment, and tolerance variation of the pin.

In addition, the type of axial spring being an RF or F affects the stress acting on the pin as well as ability to accommodate eccentricities, tolerance variations, and angular misalignment of the pin. The RF spring provides lower stress but a greater ability to accommodate for tolerances, misalignment and eccentricity. These variations affect the selection of the spring, either radial or axial and the type of radial spring and the type of groove design.

It has been discovered that for most general applications where resistivity and resistivity variability is to be kept at a minimum, a design with a tapered bottom groove having a front angle on the OD offers the best combination of properties in holding applications.

Although there has been hereinabove described specific spring holding connectors in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. In a spring holding connector, a method for creating running force differentiation between insertion of a shaft, or pin, in one direction and insertion of the shaft, or pin, in an opposite direction within a housing, said spring holding connector including a housing having a bore therethrough, a shaft, or pin, a circular groove formed in one of said bore and shaft, and a circular spring disposed in said groove for slidably holding said shaft, or pin, within said bore, said method comprising:
providing said groove with a tapered bottom;
assembling an axial F canted coil spring in said groove, said F spring comprising coils canting counterclockwise and having a back angle on an outside diameter and a front angle on an inside diameter.

2. The method according to claim 1 further comprising providing said groove in said bore.

3. The method according to claim 1 further comprising providing said groove in said shaft, or pin.

4. The method according to claim 1 wherein the one direction is a convex direction with respect to the spring and the opposite direction is a concave direction with respect to the spring.

5. The method according to claim 1 further comprising stretching a spring inside diameter upon assembly in said groove.

6. The method according to claim 1 further comprising turning a radial spring 90° upon assembly to produce the axial F canted coil spring.

7. In a spring holding connector, a method for creating running force differentiation between insertion of a shaft, or pin, in one direction and insertion of the shaft, or pin, in an opposite direction within a housing, said spring holding connector including a housing having a bore therethrough, a shaft, or pin, a circular groove formed in one of said bore and shaft, and a circular spring disposed in said groove for slidably holding said shaft, or pin, within said bore, said method comprising:
providing said groove with a tapered bottom;
assembling an axial RF canted coil spring in said groove, said RF spring comprising coils canting clockwise and having a back angle on an inside diameter and a front angle on an outside diameter.

8. The method according to claim 7 further comprising providing said groove in said bore.

9. The method according to claim 7 further comprising providing said groove in said shaft, or pin.

10. The method according to claim 7 wherein the one direction is a convex direction with respect to the spring and the opposite direction is a concave direction with respect to the spring.

11. The method according to claim 7 further comprising stretching a spring inside diameter upon assembly in said groove.

12. The method according to claim 7 further comprising turning a radial spring 90° upon assembly to produce the axial RF canted coil spring.
